(19) United States
(12) Patent Application Publication
(10) Pub. No.: US 2022/0234134 A1
(43) Pub. Date: Jul. 28, 2022

(54) ALIGNMENT DEVICE FOR A BESSEL BEAM PROCESSING OPTICAL ASSEMBLY AND METHOD

(71) Applicant: TRUMPF Laser- und Systemtechnik GmbH, Ditzingen (DE)

(72) Inventors: Daniel Flamm, Ludwigsburg (DE); Jonas Kleiner, Leonberg (DE); Julian Hellstern, Rottweil (DE)

(21) Appl. No.: 17/714,160

(22) Filed: Apr. 6, 2022

Related U.S. Application Data
(63) Continuation of application No. PCT/EP2020/077821, filed on Oct. 5, 2020.

(30) Foreign Application Priority Data
Oct. 11, 2019 (DE) 10 2019 127 481.8
Feb. 14, 2020 (DE) 10 2020 103 884.4

(51) Int. Cl. B23K 26/04; B23K 26/06; B23K 26/046

(52) U.S. Cl. CPC B23K 26/043; B23K 26/046; B23K 26/0648

(57) ABSTRACT

A device for aligning a processing optical assembly of a laser processing machine includes an entrance region for receiving a processing laser beam, a focus zone forming region for forming a measurement focus zone by the received processing laser beam along a target axis, and an imaging unit having a lens and a detector surface. The lens is configured to image measurement laser radiation that leaves the focus zone forming region after the measurement focus zone has been formed, along an imaging axis predefined by the target axis, onto the detector surface. The processing optical assembly is configured to shape a laser beam in the laser processing machine and to focus it along an incident beam axis so that a processing laser beam forms a preset Bessel beam focus zone in a workpiece to be processed.

### CROSS REFERENCE TO RELATED APPLICATIONS

This application is a continuation of International Application No. PCT/EP2020/077821 (WO 2021/069362 A1), filed on Oct. 5, 2020, and claims benefit to German Patent Application No. DE 10 2019 127 481.8, filed on Oct. 11, 2019, and No. DE 10 2020 103 884.4, filed on Feb. 14, 2020. The aforementioned applications are hereby incorporated by reference herein.

### FIELD

Embodiments of the present invention relate to a device for aligning a processing optical assembly of a laser processing machine, which forms a Bessel beam focus zone in a workpiece to be processed. Furthermore, embodiments of the present invention relate to a system for aligning a processing optical assembly and a method for aligning a processing optical assembly in a laser processing machine.

### BACKGROUND

Exemplary optical systems for beam shaping with respect to forming Bessel beams are disclosed e.g. in WO 1216/079062 A1. Underlying optical concepts may carry out for the beam shaping a phase imposing on an incident laser beam in a so-called processing optical assembly. In this case, this phase imposing may take account of a correction of aberrations such as are caused e.g. by a workpiece to be processed. By way of example, inclined or cylindrical glass workpieces lead to phase contributions which should be taken into account in the phase imposing, since otherwise the Bessel beam in the workpiece is not formed in the intended manner. However, such optical concepts implemented in processing optical assemblies are difficult to align since alignment features such as homogeneity or symmetry of the beam are no longer present on account of the aberration correction, included in the beam shaping, downstream of the workpiece and thus cannot be used for the alignment. The correct orientation of e.g. beam shaping elements and focusing lenses in the processing optical assembly is thus made more difficult.

### SUMMARY

Embodiments of the present invention provides a device for aligning a processing optical assembly of a laser processing machine includes an entrance region for receiving a processing laser beam, a focus zone forming region for forming a measurement focus zone by the received processing laser beam along a target axis, and an imaging unit having a lens and a detector surface. The lens is configured to image measurement laser radiation that leaves the focus zone forming region after the measurement focus zone has been formed, along an imaging axis predefined by the target axis, onto the detector surface. The processing optical assembly is configured to shape a laser beam in the laser processing machine and to focus it along an incident beam axis so that a processing laser beam forms a preset Bessel beam focus zone in a workpiece to be processed.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic spatial illustration of a laser processing machine for material processing with a Bessel beam focus zone,

FIGS. 2(a), 2(b), and 2(c) show schematic views for elucidating processing geometries of three exemplary workpieces,

FIG. 3 shows a schematic illustration of a device for aligning a processing optical assembly by way of example using a wedge-shaped workpiece imitation for the processing geometry according to FIG. 2(a),

FIGS. 4(a), 4(b), 4(c), and 4(d) show exemplary schematic views of beam profiles on a detector surface of a device according to embodiments of the present invention,

FIG. 5 shows a schematic illustration of a device for aligning a processing optical assembly using a workpiece imitation with a curved surface for the processing geometry according to FIG. 2(b),

FIG. 6 shows a schematic illustration of a device for aligning a processing optical assembly using a workpiece imitation with plane-parallel surfaces for the processing geometry according to FIG. 2(c),

FIG. 7 shows a schematic diagram for elucidating the measurement of a length of a Bessel beam focus zone in a workpiece imitation with plane-parallel surfaces with a device according to embodiments the present invention, and

FIG. 8 shows a flow diagram for elucidating setting modes in which the device according to embodiments of the present invention can be used.

### DETAILED DESCRIPTION

One aspect of this disclosure can make it possible to simplify alignment of a processing optical assembly in a laser processing machine. It can also make it possible to obtain information about a Bessel beam focus zone formed in the material, such as the length of the Bessel beam focus zone.

One aspect comprises a device for aligning a processing optical assembly of a laser processing machine, wherein the processing optical assembly is configured to shape a laser beam in the laser processing machine and to focus it along an incident beam axis in such a way that a processing laser beam can form a preset Bessel beam focus zone in a workpiece to be processed. The device comprises:

an entrance region for receiving the processing laser beam, a focus zone forming region provided for making it possible to form a measurement focus zone by means of the received processing laser beam along a target axis, and an imaging unit having a lens and a detector surface, wherein the lens images measurement laser radiation, which leaves the focus zone forming region after the measurement focus zone has been formed, along an imaging axis predefined by the target axis onto the detector surface.

In a further aspect, the disclosure comprises a system for aligning a processing optical assembly in a laser processing machine, wherein the processing optical assembly is configured for generating a preset Bessel beam focus zone in a substantially transparent workpiece by imposing a phase profile on a laser beam. The system comprises the laser processing machine, which has a laser beam source for generating the laser beam and the processing optical assembly, and a device as described above, comprising an imaging unit and optionally a workpiece imitation. The processing optical assembly has a beam shaping optical unit and a focusing lens unit, wherein the beam shaping optical unit is configured for the processing of the workpiece having a workpiece surface, the geometry of which corresponds to the geometry of an entrance surface of the workpiece imitation, and wherein the beam shaping optical unit together with the focusing lens unit is designed for the beam shaping of the laser beam into a processing laser beam which propagates along an incident beam axis and which can lead to the formation of the preset Bessel beam focus zone in the workpiece to be processed along a target axis. The preset Bessel beam focus zone, proceeding from an impingement point on the, in particular inclined or curved, workpiece surface, extends into the workpiece to be processed along a target axis. The laser processing machine furthermore comprises a first mount, in which the beam shaping optical unit is held laterally positionably in relation to the laser beam. The device is designed and positioned in relation to the processing optical assembly in such a way that the processing laser beam which enters the device along an incident beam axis impinges as measurement laser radiation in the far field on a detector surface of the imaging unit.

In a further aspect, the disclosure comprises a method for aligning a processing optical assembly in a laser processing machine, wherein the processing optical assembly has a beam shaping optical unit and a focusing lens unit, wherein the optical unit is positioned in the beam path of a laser beam of the laser processing machine with a first mount and is configured for phase imposing on a lateral beam profile of the laser beam, such that in the case of a correct alignment of the processing optical assembly with the focusing lens unit for a processing laser beam impinging at a predefined impingement point at a predefined angle of incidence in the workpiece a Bessel beam focus zone is generated. The method comprises the following steps: pre-aligning the processing optical assembly and the device, such that the laser beam experiences phase imposing and is focused by the focusing lens unit as a processing laser beam into a focus zone forming region, in particular into the optional workpiece imitation, (as an optional step) orienting the workpiece imitation in such a way that the processing laser beam is incident in the device along an incident beam axis and in particular impinges on the workpiece imitation, imaging a far field of a measurement laser radiation, emerging in particular from the workpiece imitation, onto an analysis plane, and aligning the position of the beam shaping optical unit and optionally the focusing lens unit in such a way as to result in a substantially rotationally symmetrical beam profile of the measurement laser radiation in in the analysis plane.

Optionally, the device described herein, comprising an imaging unit and optionally a workpiece imitation, can be set in order to image the far field of the measurement laser radiation onto the analysis plane.

In a further aspect, the disclosure comprises a method for measuring a Bessel beam focus zone, in particular a length of a Bessel beam focus zone, which is intended to be generated by a laser processing machine in a workpiece, wherein the laser processing machine has a processing optical assembly comprising a beam shaping optical unit and a focusing lens unit, wherein the optical unit is configured for phase imposing on a lateral beam profile of a laser beam, such that for a processing laser beam emerging from the focusing lens unit and impinging at a predefined impingement point at a predefined angle of incidence in the workpiece a preset Bessel beam focus zone is generated along a target direction. The method comprises the following steps:

(as an optional step) aligning a processing optical assembly according to the method described above, such that a processing laser beam is focused into a focus zone forming region, in particular into the optional workpiece imitation, while forming a measurement focus zone, and scanning the measurement focus zone by focusing the measurement laser radiation, emerging in particular from the workpiece imitation, by means of a lens onto an analysis plane while displacing the lens along an imaging axis.

Optionally, the device described herein, comprising an imaging unit and optionally a workpiece imitation, can be set for focusing the measurement laser radiation onto the analysis plane.

In some embodiments of the device, the lens and the detector surface can be arranged along the imaging axis and the detector surface can be part of a camera. In particular, the lens can be assigned a lens axis running parallel to the imaging axis and/or the detector surface extends in a plane to which the imaging axis runs perpendicularly.

In some embodiments of the device, the imaging unit furthermore can have a stop for mounting a workpiece imitation, wherein the stop defines a stop area in a predetermined orientation with respect to the imaging axis. The stop area can be provided in particular for an orthogonal orientation of a plane exit surface of the workpiece imitation with respect to the target axis.

In some embodiments of the device, the imaging unit can comprise:

a translation unit for displacing the lens along the imaging axis,

a translation unit for displacing the detector surface along the imaging axis, and/or

a translation unit for jointly displacing the lens and the detector surface along the imaging axis.

Optionally at least one of the translation units can be designed for setting a distance between the respective component and the focus zone forming region, in particular a stop for mounting a workpiece imitation.

In some embodiments, the device can furthermore have a rotation unit configured for the rotatable mounting of the imaging unit in order to provide a rotation of the imaging axis with respect to the incident beam axis.

In some embodiments, the device can furthermore have a workpiece imitation as an alignment element, which has an entrance surface and a plane exit surface and is arranged in the focus zone forming region in such a way that

the plane exit surface is oriented perpendicularly to the target axis,

the entrance surface, at an impingement point at which the processing laser beam impinges on the workpiece imitation along the incident beam axis, is arranged with respect to the incident beam axis in such a way that the target axis running through the workpiece imitation runs in a predefined direction given in particular by the preset Bessel beam focus zone.

In developments, the imaging unit can furthermore have a stop for mounting the workpiece imitation, wherein the stop defines a stop area for mounting the workpiece imitation in a position in which the exit surface is oriented perpendicularly to the imaging axis. Additionally or alternatively, the orientation of the target axis with respect to the incident beam axis can be given by a refractive index of the workpiece imitation and can be defined in particular in relation to an impingement point of the laser beam along the incident beam axis.

In developments, the entrance surface can form in sections a shape of a lateral surface of a cylinder. Optionally in the case of a radial course of the incident beam axis with respect to the shape of a lateral surface of a cylinder, the plane exit surface can run perpendicularly to the incident beam axis.

In developments, the target axis can run orthogonally or non-orthogonally with respect to a tangential plane at the impingement point of the entrance surface. Furthermore, the incident beam axis can optionally run at an angle in the range of 0° to 50°, in particular in the range of 20° to 40°, with respect to a normal vector of the tangential plane.

In some embodiments of the device, the imaging unit in a first operating setting can be designed to capture a transverse beam profile of the measurement laser radiation in the far field, and in a second operating setting can be designed, by means of the positioning of the lens and the camera, to image a start or an end of a measurement focus zone formed, in particular in the workpiece imitation, onto the detector surface.

In some embodiments of the system, the workpiece imitation of the device can be oriented and positioned in relation to the processing optical assembly in such a way that the processing laser beam which is incident on the workpiece imitation along the incident beam axis emerges from the workpiece imitation as the measurement laser radiation.

In some embodiments of the system, the laser processing machine can furthermore comprise a second mount, in which the focusing lens unit is held positionably in relation to the optical unit laterally and optionally along an optical axis of the focusing lens unit.

In some embodiments of the system, a camera of the imaging unit can be configured for outputting an image recording of a beam profile in the far field of the measurement laser radiation emerging from the workpiece imitation.

In some embodiments of the system, the beam shaping optical unit can comprise a planar diffractive optical element configured to impose a two-dimensional Bessel beam shaping phase distribution on the laser beam.

In some embodiments of the system, furthermore in the aligned state of the processing optical assembly the first mount can position the beam shaping optical unit and the second mount can position the focusing lens unit in such a way that the beam profile of the far field on the detector surface is substantially rotationally symmetrical with respect to the imaging axis.

In some embodiments of the system, a region in which the geometry of the entrance surface of the workpiece imitation corresponds to the geometry of the workpiece surface of the workpiece to be processed, which forms the basis for the preset Bessel beam focus zone, can be dimensioned in such a way that a measurement focus zone is formed in the workpiece imitation substantially over a length of the preset Bessel beam focus zone.

The concepts proposed herein make it possible to align a processing optical assembly, with the aim of ensuring an undisturbed formation of a Bessel beam focus zone in a workpiece despite an aberration-causing geometry of a workpiece to be processed. Moreover, the concepts proposed herein make it possible to measure the Bessel beam focus zone such as is formed in a workpiece.

A possible modular set-up of a device according to embodiments of the present invention furthermore allows the use of different workpiece imitations with the same imaging unit.

Concepts which allow the improvement of aspects from the prior art at least in part are disclosed herein. In particular, further features and their expediences will become apparent from the following description of embodiments with reference to the figures.

The aspects described herein are based in part on the insight that during the processing of a workpiece with a laser beam, optical conditions can arise which necessitate a compensation of aberration-causing influences of optical components and in particular of the workpiece to be processed. This compensation in the phase distribution over the two-dimensional lateral beam profile can be integrated into a processing optical assembly. The inventors have recognized that an alignment of the specifically adapted processing optical assembly is made more difficult by the phase compensation. The alignment can nevertheless be performed if correspondingly aberration-causing optical elements, called workpiece imitations herein, according to embodiments of the present invention are used during the alignment and for the analysis of the beam path. In this case, the workpiece imitation is positioned in the beam path in such a way that the desired Bessel beam focus zone is formed in the workpiece imitation. The workpiece imitation is thus formed like the workpiece to be processed on the entrance side.

For the analysis of the Bessel beam focus zone, the inventors have now furthermore recognized that the workpiece imitation can be formed on the exit side such that the laser radiation emerging from the workpiece imitation becomes accessible to analysis. For this purpose, it is proposed to form the exit side of the workpiece imitation as a plane exit surface and to orient the plane exit surface in relation to the Bessel beam focus zone intended in the workpiece in such a way that a target axis extending along a Bessel beam focus zone formed as desired runs perpendicularly to the exit surface. According to embodiments of the present invention, the laser beam emerging from the exit surface is subsequently imaged onto a detector surface with the aid of a lens.

Furthermore, the inventors have recognized that, with this proposed optical concept, properties of the Bessel beam focus zone can be measured if the position of the lens is set accordingly. In this case, the proposed measurement concepts can be used under aberration-causing optical configurations that necessitate the use of a workpiece imitation, and also in the case of aberration-free optical configurations (e.g. also without a workpiece imitation). By way of example, scanning of the intensity in the Bessel beam focus zone can be performed by scanning (moving) the lens along the target axis, i.e. along the beam propagation direction in the workpiece given correct alignment. The length of the Bessel beam focus zone that is actually present in the workpiece imitation can be determined in this way. Said length is then also present in the workpiece to be processed, assuming that the entrance side is correspondingly configured, i.e. formed and oriented.

Furthermore, the proposed optical concept, in particular the module, can be used to measure the optical thickness of a plane substrate or the aberrations occurring as a result of the substrate by means of the measurement of the ring width at a position or the intensity along the focus zone.

Generally, the concept proposed herein for aligning a processing optical assembly of a laser processing machine can be implemented with a system having the aberration-causing elements and optionally also aberration-correcting elements. The alignment of the processing optical assembly can be based for example on an image processing of beam profile recordings of a detector positioned downstream of the aberration-causing elements. By virtue of the compensation of the aberration with the workpiece imitation, said compensation being performed in a “workpiece-like” manner, simple alignment features such as the symmetry of a ring-shaped beam profile are present.

Embodiments of the present invention utilize a workpiece imitation as an optical alignment element which compensates for the aberration (by way of example an oblique edge or a cylindrical lens in the following figures). The workpiece imitation serves for imitating the planned entrance angle and the planned entrance geometry such as has been taken into account in the effected aberration compensation in the beam shaping element. The geometry and shaping of the workpiece imitation furthermore enable an orthogonal exit from a plane test surface (rear side) of the workpiece imitation, such that given correct alignment the Bessel beam can propagate “correctly” again (without an aberration corrector) and the symmetry of the beam profile can thus be assessed and used for the alignment.

Embodiments of the present invention are described in further detail by way of example below with reference to the figures.

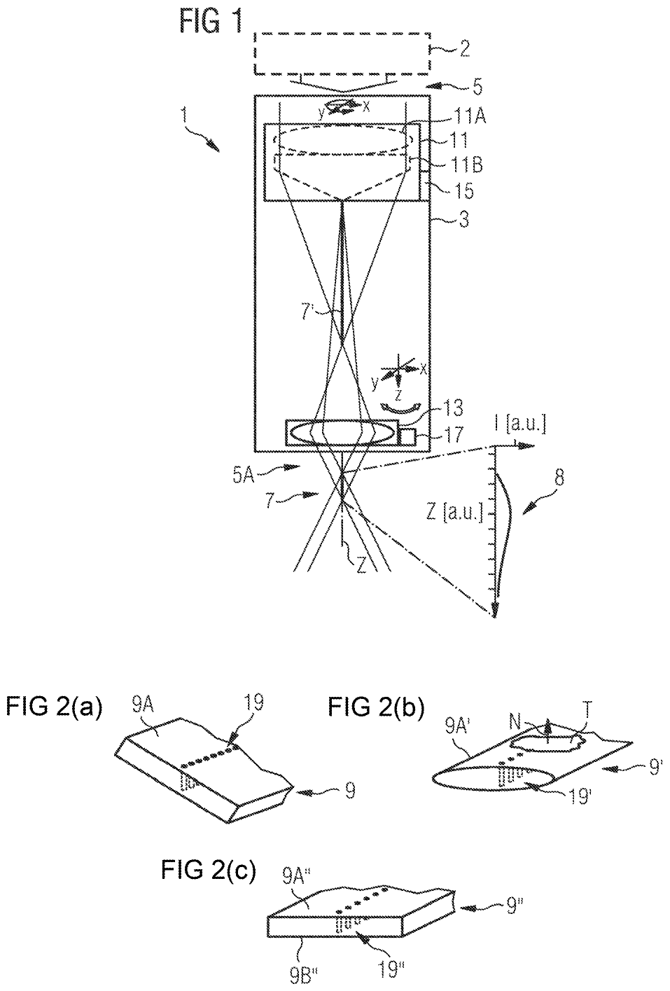

FIG. 1 is a schematic illustration of a laser processing machine 1, configured for material processing, for example for laser cutting of transparent material plates or for introducing material modifications into transparent materials.

The laser processing machine 1 comprises a laser beam source 2 for generating a primary laser beam 5, and also a processing optical assembly 3. The processing optical assembly 3 is configured to shape the laser beam 5 in such a way that a desired focus zone 7 is formed in a workpiece (see e.g. workpieces 9, 9′, 9″ in FIG. 2). By way of example, the processing optical assembly 3 comprises a beam shaping optical unit 11 and a focusing lens unit 13 (also referred to as processing objective lens). By way of example, FIG. 1 indicates that the beam shaping optical unit 11 can be configured for phase imposing of a lens 11A and of an axicon 11B. The beam shaping optical unit 11, e.g. as a planar diffractive optical element, in particular as a spatial light modulator (SLM) or as phase plates, i.e. settable or fixedly set in terms of phase, can impose a predetermined two-dimensional phase distribution on the incident laser beam 5, in particular over the transverse beam profile thereof. In this respect, reference is made by way of example to WO 1216/079062 A1 cited in the introduction.

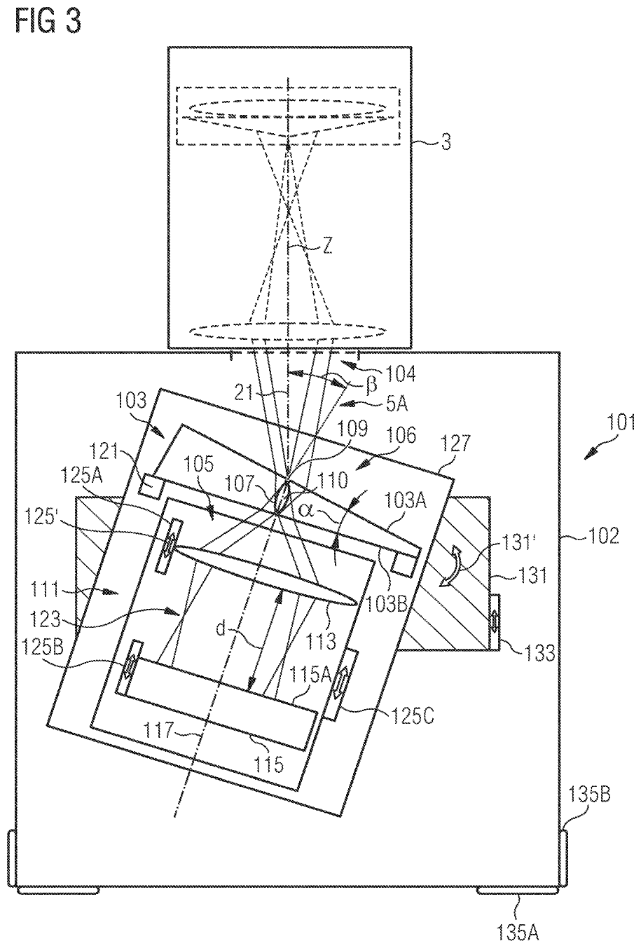

In the example of the arrangement in FIG. 1, the beam shaping optical unit 11 brings about a real Bessel beam focus zone 7′ downstream of the beam shaping optical unit 11. The focusing lens 13 (together with the imposed phase of the lens 11A) images said real Bessel beam focus zone 7′ onto the Bessel beam focus zone 7 in reducing fashion, with the result that high intensities such as are required for an intended material processing of a workpiece are generated in the Bessel beam focus zone 7. The laser beam emerging from the processing optical assembly 3 is indicated in FIG. 3 by way of example as a focused Bessel beam 5A that forms a ring-shaped beam profile.

FIG. 1 schematically shows a profile 8 of the intensity I in the Bessel beam focus zone 7. It is assumed here that the processing optical assembly 3 is formed in such a way that given correct alignment the Bessel beam focus zone 7 is formed along a target axis (in the Z-direction in FIG. 1). The Bessel beam focus zone 7 can extend over a few 100 μm and thus generate e.g. elongated modification zones in the material.

Furthermore, a mount 15 for the beam shaping optical unit 11 and a mount 17 for the focusing lens unit 13 are evident in FIG. 1. The mounts 15, 17 can provide translational or rotational degrees of freedom for the alignment. By way of example, the mount 15 can enable for example an alignment of the beam shaping optical unit 11 in the X-Y-plane and also possibly a rotation of the beam shaping optical unit 11 in the X-Y-plane. The mount 17 can allow for example a setting of the position of the focusing lens unit 13 in the X-Y-plane and also possibly a translation of the focusing lens unit 13 in the Z-direction.

If the Bessel beam focus zone 7 is positioned in a workpiece and the laser beam 5 with the required power is coupled in, the laser radiation interacts with the material of the workpiece in the Bessel beam focus zone 7 and brings about the intended modification of the material structure over the length of the Bessel beam focus zone 7. A strung together line of introduced modifications in the workpiece can be used e.g. for separating the workpiece into two parts.

However, when the laser beam 5A enters the workpiece, the formation of the Bessel beam focus zone 7 in the material can be influenced by the course of the surface of the workpiece and the refractive index of the material of the workpiece if the phase contributions caused during entrance are not taken into account.

As is shown in FIG. 2(a), for example, a material processing can be carried out with a Bessel beam focus zone which runs at an angle with respect to an entrance surface 9A of a workpiece 9. By way of example, FIG. 2(a) indicates a strung together line of correspondingly generated modifications 19 in the workpiece 9. The modifications 19 in the workpiece 9 can be generated for example with a sequence of laser pulses in combination with a linear movement of the workpiece 9 relative to the Bessel beam focus zone.

However, an oblique incidence on the entrance surface 9A leads to an astigmatic disturbance of the laser beam propagating in the workpiece 9, as a result of which the interference behavior of the laser radiation is also influenced. In order to form an undisturbed Bessel beam focus zone in the workpiece 9, the shape of which Bessel beam focus zone corresponds to the Bessel beam focus zone 7 shown in FIG. 1, precompensation of the astigmatic disturbance can be effected by adapting the phase imposing with an aberration correction. In the arrangement in FIG. 1, this precompensation can be performed by the beam shaping optical unit 11 and be included in the calculation of the two-dimensional phase imposing, for example.

FIG. 2(b) shows a further example of an astigmatism-generating workpiece geometry of a workpiece 9′. The workpiece 9′ has an entrance surface 9A′ that is curved in one direction. In the exemplary case in FIG. 2(b), modifications 19′ are intended to be introduced into the workpiece 9′ orthogonally with respect to a tangential plane T to the curved entrance surface 9A′ (i.e. parallel to a normal vector N of the tangential plane T). On account of the curvature of the entrance surface 9A′ in one direction, here as well it is necessary to perform an aberration correction with the beam shaping optical unit 11 in such a way that the laser radiation, in a manner free of aberrations, shapes the Bessel beam focus zone in the workpiece 9′ and forms the modifications 19′ as desired.

For completeness, FIG. 2(c) shows a workpiece 9″ with a plane entrance surface 9A″ and an exit surface 9B″ parallel thereto. The workpiece 9″, thus formed in plane-parallel fashion, is intended to be provided with modifications 11″ running orthogonally with respect to the entrance surface 9A″, for example, wherein a predetermined length of the modifications 11″ in the material is intended and this length is intended to be verified, for example.

In order to be able to ensure a desired formation of the Bessel beam focus zone in the workpiece, a correct alignment of the beam shaping optical unit 11 and the focusing lens unit 13 is required. This alignment can be effected for example by setting of the mounts 15, 17. However, it is not always possible to check the alignment in the case of aberration-causing workpiece configurations. Firstly, aberration-compensating phase imposings prevent the direct measurement of the focus zone of the laser beam 5A (without a workpiece). Secondly, the laser radiation emerging from the workpiece may experience a further aberration at the rear side, with the result that the analysis of the laser radiation emerging from the workpiece also does not allow the shape of the focus zone formed to be deduced directly.

The optical concept of the laser processing machine 1 illustrated in FIG. 1 can be briefly summarized as follows. A central, beam shaping element of a processing optical assembly acts equally for imposing an axicon-like phase, for carrying out an aberration (pre)correction and optionally for completing a telescope arrangement by imposing a “lens” phase contribution. The laser beam passes through the beam shaping element and is focused onto/into a substantially transparent optical workpiece by a focusing optical assembly (e.g. a microscope objective) for the purpose of material processing.

FIG. 3 then elucidates by way of example for the processing geometry according to FIG. 2(a) a device 101 for aligning the beam shaping processing optical assembly 3.

In the device 101 a wedge-shaped workpiece imitation 103 is used to reproduce the optical configuration from FIG. 2(a) on the entrance side. In this case, the components explained below, including the workpiece imitation 103, can be arranged in a housing 102.

The housing 102 has an entrance region 104, through which the laser beam 5A emerging from the processing optical assembly 3 is coupled into the device 101. The entrance region 104 is formed for example by an opening in the housing 102.

The device 101 furthermore provides a focus zone forming region 106, in which the laser beam 5A forms a Bessel beam focus zone for alignment purposes or for measurement purposes.

The workpiece imitation 103 is situated in the focus zone forming region 106 of the exemplary device 101 in FIG. 3. The workpiece imitation 103 is wedge-shaped, i.e. a plane entrance surface 103A runs at an angle α (in an angle range of 0° to 32°, in particular in the range of 13° to 26°) with respect to a plane exit surface 103B. At an impingement point 109, the laser beam 5A impinges on the entrance surface 103A at an angle β and was chosen for the material processing in accordance with FIG. 2(a) in such a way that given correct alignment of the processing optical assembly 3 the desired Bessel beam focus zone is formed in the direction sought (referred to herein as target axis 110).

For this purpose, however, the phase imposing performed in the processing optical assembly 3 would take account of the angle β and the astigmatic disturbance resulting therefrom. Assuming that a correct alignment and a necessary precompensation are present, the desired Bessel beam focus zone extends along the target axis 110 in the workpiece or in the workpiece imitation 103. The focus zone in the workpiece imitation 103 is referred to hereinafter as measurement focus zone 107.

According to embodiments of the present invention, the workpiece imitation 103 is shaped with regard to its exit surface 103B in such a way that the exit surface 103B runs perpendicularly to the target axis 110. If this is the case and a correct alignment and a necessary precompensation are present, laser radiation emerges from the workpiece imitation 103 in a Bessel beam-like and undisturbed manner. The laser radiation emerging from the workpiece imitation 103 is referred to herein as measurement laser radiation 105, which is detected by an imaging unit 111 and is used for aligning the processing unit 3 and/or for measuring the focus zone formed.

The beam path of the measurement laser radiation 105 as shown in FIG. 3 is based on a correct alignment of the processing optical assembly 3. After emerging from the workpiece imitation 103, an intensity ring widening along the target axis 110 is evident in FIG. 3.

With regard to the alignment of the processing optical assembly, depending on the surface shape of the workpiece imitation, the aberration correction of the beam shaping element (of the beam shaping optical unit 11) and the aberrations during entrance into the workpiece imitation 103 cancel one another out, such that the usual propagation of a Bessel beam and the shaping of a symmetrical and homogeneous far field (intensity) ring occur in the downstream course (after emergence from the workpiece imitation assuming a correct alignment).

In the imaging unit 111, the far field ring can be collimated by a further objective lens (e.g. a microscope objective)—illustrated as lens 113 by way of example in FIG. 3—and can be recorded by a camera 115 as detector. Lens 113 constitutes for example an objective lens like the processing objective lens 13 used for processing. The objective lens has for example an NA which is greater than or equal to the NA of the processing objective lens. The objective lens has for example a working distance which is larger than the effective region to be measured. The setting of the imaging unit 111 for detecting the measurement laser radiation in the far field corresponds to a first setting for alignment on the basis of a captured transverse beam profile.

The optical elements of the processing optical assembly 3 can then be aligned, wherein the symmetry and homogeneity of the far field ring of the measurement laser radiation 105 can be used as a criterion.

For the purpose of analyzing the measurement laser radiation 105, the device 101 has an imaging unit 111. The imaging unit 111 comprises a lens 113 and a camera 115. The camera 115 is configured for example as an area detector, in particular as a CCD camera, and makes it possible to record a lateral beam profile (in particular to repeatedly record an image of the beam profile) in the far field. The image recording is effected by a detector, which captures e.g. intensity distributions of the incident measurement laser radiation 105 in an analysis plane/area (given by the detector surface 105).

As indicated in FIG. 3, the imaging unit 111 and in particular the lens 113, is assigned an imaging axis 117, which is intended (largely) to correspond to the target axis 110 of the respective workpiece imitation for the analysis of the measurement laser radiation 105. In FIG. 3, the imaging axis 117 runs through the center of the lens 113, orthogonally with respect to a lens plane of the lens 113 and orthogonally with respect to the exit surface 103B.

In order to ensure the orientation of target axis 110 and imaging axis 117 for different workpiece imitations, a stop 121 can be provided, for example, which defines a plane perpendicular to the imaging axis 117. The workpiece imitations can then be incorporated using the stop 121 in such a way that their exit surfaces 103B each run perpendicularly to the imaging axis 117. In other words, the workpiece imitation (if required) can be installed purely by way of mechanical tolerance allowance in the device 101. The workpiece imitation 103 and the imaging unit 111 can then be oriented jointly such that the laser beam 5A enters the workpiece imitation 103 at the angle β at the impingement point 109.

The entire device can likewise be oriented with respect to the processing optical assembly by way of mechanical stops. For the orientation of the entire device, it is furthermore possible, for example, on the basis of the raw beam position that was previously oriented perpendicularly to the device, for a centroid determination to be carried out by means of the camera installed in the device.

As shown in FIG. 3, the detector (the camera 115) is arranged downstream of the lens 113, such that it is intended to capture the far field (or slightly offset from a possible focus 123 in the far field since the focus 123 itself may be too sharp/intensive) as a ring with a uniform/homogeneous intensity.

The lens 113 collimates/focusses the measurement laser radiation 105 emerging divergently from the workpiece imitation 103, such that said radiation can be recorded by the camera 115. In FIG. 3, a distance d between a detector surface 115A of the camera 115 and the lens 113 is chosen in such a way that the measurement laser radiation 105 impinges on the detector surface 115A outside the intermediate focus 123.

Prerequisites for aligning the processing optical assembly 3 with the aid of the device 101 are that the imaging unit 111 is positioned correctly in relation to the target axis 110 and that, for the case where a workpiece imitation is used, the entrance surface of the workpiece imitation is oriented with respect to the processing optical assembly 3, assuming a correct alignment, in a manner corresponding to the workpiece to be processed. As has already been mentioned, this last has the effect that given a correct alignment of the processing optical assembly, the Bessel beam focus zone in the workpiece imitation corresponds to the intended Bessel beam focus zone in terms of its propagation direction and shape.

These prerequisites can be achieved for example for a specific application with optical components positioned fixedly with respect to one another. At least in some instances, however, a settability of the positions of the optical components may also be expedient. A number of aspects of settability are described below, which can be used individually or jointly in order to bring firstly the imaging unit 111 and secondly the workpiece imitation 103 into a position with respect to the processing optical assembly 3 that is provided for the alignment.

The imaging unit 111 can comprise one or more translation units. By way of example, a translation unit 125A (e.g. axial displacement stage) for displacing the lens 113, a translation unit 125B for displacing the detector surface 115A or the camera 115 and a translation unit 125C for jointly displacing lens 113 and detector surface 115A or camera 115 are indicated in FIG. 3. In this case, the translation units 173A to 125C are preferably oriented in such a way that the displacement is effected along the imaging axis 117 and in particular in relation to the stop 121. The translation is elucidated by way of example by a translation arrow 125′.

By way of example, the translation unit 125A can be configured for setting a distance between the lens 113 and the focus zone forming region 106 along the imaging axis 117. In particular, the translation unit 125A can be configured for moving a lens focus position assigned to the lens 113 in relation to the Bessel beam focus zone. By way of example, a translation unit 125B can be configured for setting a distance between the lens 113 and the detector surface 115A in order to position the detector surface 115A outside the intermediate focus 123.

Optionally, it is furthermore possible, with a translation unit 125C, to set the distance of lens 113 and detector surface 115A with respect to the focus zone forming region 106 (the distance with respect to the exit surface 103B with workpiece imitations having been mounted) while maintaining an imaging situation between lens 113 and detector surface 115A. The joint displacement can serve for setting the diameter of the beam profile on the detector surface 115A. It furthermore makes it possible to bring the measurement focus zone 107 into the focus of the lens 113 if a geometry of the measurement focus zone is intended to be measured.

Furthermore, FIG. 3 indicates a rotation unit 131, which allows an orientation of the imaging unit 111, in particular of the target axis 110/imaging axis 117, with respect to an incident beam axis 21 and thus a setting of the angle β. The rotation is elucidated by way of example by a rotation arrow 131′. By way of example, the optical components of the imaging unit 111 and the stop 121 for the workpiece imitation 103 are mounted on a common baseplate 127.

Moreover, the entire unit comprising workpiece imitation and imaging unit 111 (optionally including the rotation unit 131), can be settable at a distance in relation to the processing optical assembly 3 along the incident beam axis 21 by means of a further translation unit 133.

Finally, FIG. 3 indicates by way of example further orientation stops 135A, 135B, which can be provided on a workpiece mount of the laser processing machine 1 in order to position the device 101 in relation to the processing optical assembly 3. In this case, the stops 135A relate to a positioning of the device 111 in the Z-direction and the stops 135B relate to a positioning of the device 111 in the X/Y-direction. The positioning of the device 111 in the X/Y-direction orients the entrance region with respect to the target beam position/location of the laser beam 5A emerging from the processing optical assembly 3. Depending on the settability of the different components of the device 111, a settability of one (or more) orientation stop 135A, 135B in the X-, Y- or Z-direction can further be provided.

Beam profiles such as are present at the detector surface 115A (as analysis plane), said beam profiles being recorded by the camera 115, can be used for the alignment of the processing optical assembly. Preferably, the detector surface 115A is oriented perpendicularly to the imaging axis 117. Correction information for setting the position of the optical components of the processing optical assembly 3 can be afforded by visual or automated evaluation of the recordings during manual or automated setting of the positions of the optical elements of the processing optical assembly 3.

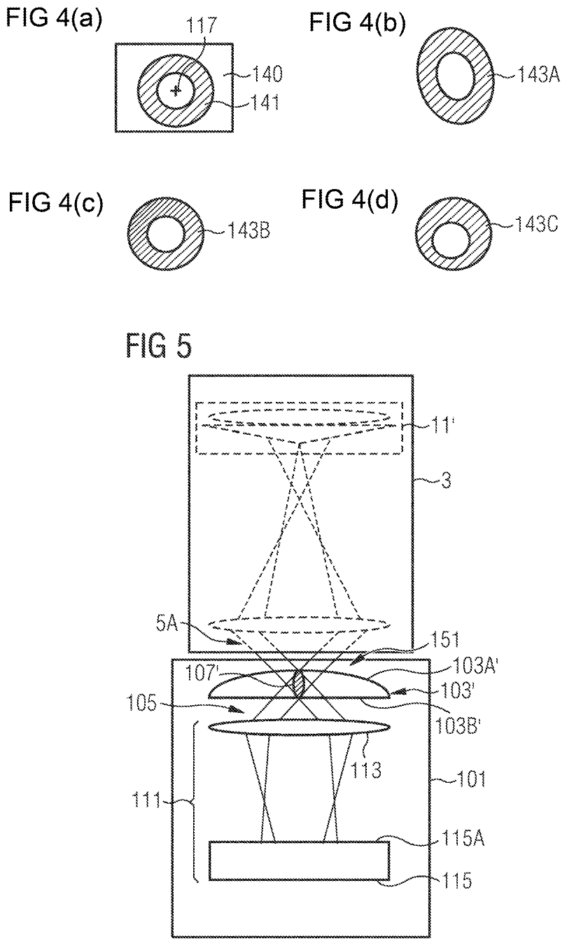

FIG. 4(a) shows a recording 140 by the camera 115 of a beam profile 141 such as is present given a correct alignment, said bean profile impinging on the detector surface 115A. The beam profile 141 is rotationally symmetrical and represents a homogeneous intensity ring. For completion, FIG. 4(a) indicates the position of the imaging axis 117 in the center of the beam profile 141.

The beam profile 141 constitutes a target beam profile that is intended to be attained by means of corresponding setting of the position of the beam shaping optical unit 11 and of the focusing lens unit 13.

If the beam shaping optical unit 11 or the focusing lens unit 13 is not arranged correctly in terms of its position in the processing optical assembly 3, deformations of the beam profile on the detector surface 115A may result. FIGS. 4(b) to 4(d) show by way of example beam profiles which require realignment of the beam shaping optical unit and/or of the focusing lens unit.

FIG. 4(b) shows an intensity ring 143A which is deformed, but largely homogeneous with respect to the intensity. FIG. 4(c) shows a symmetrical intensity ring 143B, wherein the intensity distribution varies azimuthally over the ring. FIG. 4(d) shows a beam profile in which the thickness of a ring-shaped intensity region 143C varies.

By means of setting of the positions of the beam shaping optical unit 11 and/or of the focusing lens unit 13 with the aid of the mounts 15, 17, the processing optical assembly 103 is aligned with the aim of forming a beam profile 141 on the detector surface 115A as illustrated in FIG. 4(a).

FIG. 5 elucidates the use of a workpiece imitation 103′ for the processing geometry shown in FIG. 2(b). The workpiece imitation 103′ has an entrance surface 103A′, which is an area curved in one direction at least in one section 151. The entrance surface 3A′ can be formed for example as a lateral surface of a cylinder. FIG. 5 reveals the curvature in the schematic sectional illustration.

Accordingly, the ring-shaped processing laser beam 5A will propagate in the workpiece to be processed and also in the workpiece imitation 103′ differently in the direction of the curvature than in the direction in which no curvature is present. Accordingly, the beam shaping optical unit 11′ used in the processing optical assembly 3 will perform phase imposing on the laser beam 5 which performs a corresponding aberration correction.

It is evident on the basis of this example once again that besides a positioning of the components of the beam shaping optical unit 11′, the correct orientation thereof in terms of the angle about the optical axis is also necessary in order to reconcile the beam shaping optical unit 11′ with the orientation of the workpiece to be processed.

In the example in FIG. 5, analogously to FIG. 2(b), the measurement focus zone 107′ is formed orthogonally with respect to a tangential plane. Accordingly, an exit surface 103B′ of the workpiece imitation 103′ is parallel to said tangential plane. With regard to the embodiment of the imaging unit 111 and also the optionally possible settability of its components, reference is made to the description of FIG. 3.

The geometry shown in FIG. 5 is one example of a processing geometry in which a target axis of a Bessel beam focus zone runs orthogonally with respect to a tangential plane, wherein the tangential plane is spanned in relation to the workpiece to be processed or the workpiece imitation at an impingement point of the entrance surface at which the processing laser beam impinges on the workpiece imitation along the incident beam axis.

The person skilled in the art will recognize that in a processing geometry in which the target axis of a Bessel beam focus zone does not run orthogonally with respect to a tangential plane at the impingement point in the workpiece to be processed or in the workpiece imitation, more extensive phase corrections would be performed with the beam shaping optical unit. These phase corrections can also be taken into account in the alignment in the case of correspondingly orthogonal orientation of the exit surface of the workpiece imitation.

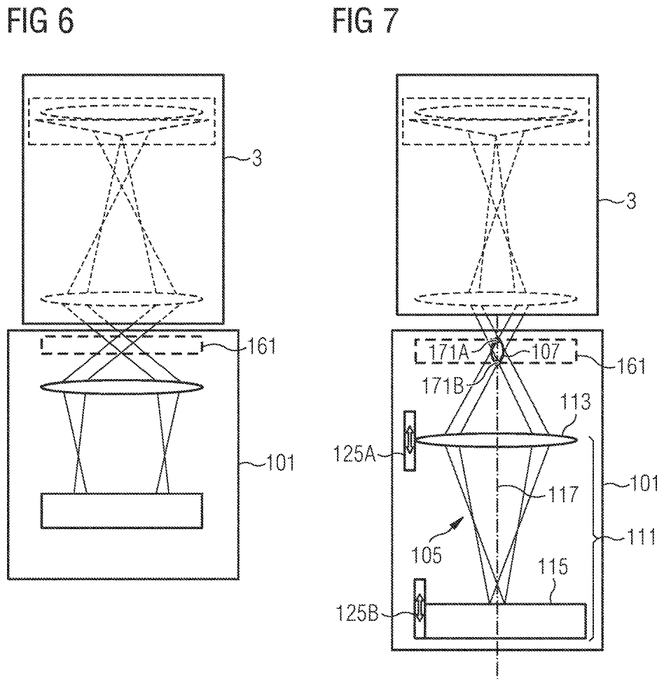

FIG. 6 shows that the device 101 can also be used for aligning a processing optical assembly with a beam shaping optical unit if the intention is to process for example a plane-parallel plate with a Bessel beam focus zone. In this case, the alignment can be performed with or without a (plane-parallel) workpiece imitation 161 (illustrated in a dashed manner).

FIG. 6 accordingly shows that an entrance surface 161A of the workpiece imitation 161 is formed as a plane area (at least) in the entrance region of the processing laser beam 5A. Given the assumed orthogonal course of the incident beam axis with respect to the entrance surface, the exit surface runs parallel to the entrance surface.

FIG. 7 elucidates the use of the device 101 when measuring a measurement focus zone on the basis of the example of the plane-parallel workpiece imitation 161 from FIG. 6. The device 101 enables scanning of the intensity profile in the measurement focus zone 107 and thus for example the determination of the actual length of the Bessel beam focus zone in the workpiece imitation/workpiece by means of scanning the imaging unit 111 along the imaging direction 117. In FIG. 7, the imaging direction 117 and the incident beam axis 21 correspond by way of example.

It is evident (in particular in comparison with FIG. 6) that the arrangement of lens 113 and camera 115 in the imaging unit 111 exhibits a larger distance between the lens 113 and the workpiece imitation 161/measurement focus zone 107. Accordingly, the measurement laser radiation 105 converges on the detector surface 115A; it is evident in FIG. 7 that the diameter of the ring-shaped intensity distribution decreases along the imaging axis 117 between lens 113 and camera 115.

In FIG. 7, the detector 115 is positioned at the focus of the converging measurement laser beam.

The setting of the imaging unit 111 for measuring the measurement focus zone 107 as shown in FIG. 7 corresponds to a second operating setting for checking the phase imposing and the resulting focus zone for phase imposing with the beam shaping element. Upon changing to this second operating setting, the translation units 125A to 125B elucidated in FIG. 3 can be used for the positioning of lens 113 and detector 115. Proceeding from an orientation of the imaging axis 117 with respect to the incident beam axis 21 that is performed for the alignment of the processing head 3, usually it is not necessary to perform an adaptation of the angular position for the second operating setting.

In order to use the optical configuration of the imaging unit 111 for scanning the measurement focus zone extending over a few 100 μm, for example the translation unit 125C (see FIG. 3) can be used for jointly displacing lens 113 and detector 115 along the imaging axis 117. In this way, e.g. a start 171A and an end 171B of the measurement focus zone 107 can be determined in order e.g. to capture or to check the exact position and the length of the measurement focus zone 107.

The person skilled in the art will recognize that a similar configuration of the imaging unit 111 can be used for example for measuring measurement focus zones like those shown in FIGS. 3 and 5.

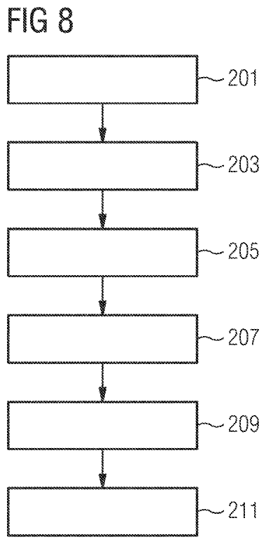

FIG. 8 shows an exemplary flow diagram for the first operating setting of the device 101, said first operating setting having been elucidated in association with FIG. 3, and the second operation setting of the device 101, said second operating setting having been elucidated in association with FIG. 7.

FIG. 8 relates to the method for aligning the processing optical assembly, wherein optionally a method for measuring a focus zone is appended (or can be carried out independently).

A first step 201 involves pre-aligning the processing optical assembly and the device, such that a laser beam of the laser beam source experiences a phase imposing and is focused as a processing laser beam into a focus zone forming region along an incident beam axis by the focusing lens unit. If a workpiece imitation is used, the focus zone forming region comprises the workpiece imitation and the focusing and formation of the measurement focus zone are effected in the workpiece imitation.

Optionally, in a step 203, the workpiece imitation can be oriented in such a way that the processing laser beam is incident along an incident beam axis assigned to the device and impinges on the workpiece imitation in particular at an angle β of incidence.

A step 205 involves imaging a far field of a measurement laser radiation, emerging in particular from the workpiece imitation, onto an analysis plane. (The measurement laser radiation corresponds to the residual radiation of the processing laser beam that has passed through the workpiece imitation.) By way of example, the device disclosed herein for aligning a processing optical assembly of a laser processing machine can be used in order to image the far field of the measurement laser radiation onto the analysis plane.

Using the imaging of the measurement laser radiation onto the analysis plane, in step 207 the position of the beam shaping optical unit, and optionally the position of the focusing lens unit, is then aligned (i.e. set and in particular the locations thereof are oriented) in such a way as to result in a substantially rotationally symmetrical beam profile of the measurement laser radiation in the analysis plane.

FIG. 8 furthermore shows a step 209 of a method for measuring a length of a measurement focus zone in a workpiece imitation, wherein that is intended to be generated by a laser processing machine for material processing in a workpiece.

If the method for alignment comprising the steps 201 to 207 has been carried out, for example, the measurement focus zone can be scanned by focusing the measurement laser radiation, emerging in particular from the workpiece imitation, by means of a lens onto an analysis plane while displacing the lens along the target direction. In this case, once again the device disclosed herein for aligning a processing optical assembly of a laser processing machine can also be used for focusing the measurement laser radiation onto the analysis plane (step 211).

Further aspects of the present disclosure are summarized below.

A device (101) for aligning a processing optical assembly (3) of a laser processing machine (1), wherein the processing optical assembly (3) shapes and focusses a laser beam (5) in the laser processing machine (1) in such a way that a processing laser beam (5A) can form, in an aberration-correcting manner, a preset Bessel beam focus zone (7) in a workpiece (9) to be processed, comprising:

an alignment element (103) having an entrance surface (103A) and a plane exit surface (103B), wherein

the entrance surface (103A) is assigned an optionally aberration-causing incident beam axis (21) for the incident processing laser beam (5A),

the incident beam axis (21) is assigned a target axis (110) for the preset Bessel beam focus zone (7), said target axis running through the alignment element (103), and

the plane exit surface (103B) is oriented perpendicularly to the target axis (110), and

an imaging unit (111) having a lens (113) and a camera (115), which are oriented in relation to an imaging axis (117), wherein the lens (113) is provided for imaging a measurement laser beam (105), emerging from the alignment element (103), along the imaging axis (117) onto a detector area (115A) of the camera (115) and the imaging axis (117) is oriented perpendicularly to the plane exit surface (103B).

In this case, the entrance surface (103A) can be formed as a plane area which runs at an angle in the range of 0° to 45°, or in the range of 0° to 32°, in particular in the range of 10° to 30° or 10° to 26°, with the exit surface (103B).

The target axis (110) can run orthogonally or non-orthogonally with respect to a tangential plane (T) at an impingement point (109) of the entrance surface (103A), at which the processing laser beam (5A) impinges on the alignment element (103) along the incident beam axis (21). The incident beam axis (21) can optionally run at an angle in the range of 0° to 50° or of 0° to 45°, in particular in the range of 10° to 30° or of 20° to 40°, with respect to a normal vector (N) of the tangential plane (T).

A system for aligning a processing optical assembly (3) in a laser processing machine (1), wherein the processing optical assembly (3) is configured for generating a preset Bessel beam focus zone (7) in a substantially transparent workpiece (9) by imposing a phase profile on a laser beam (5), comprising:

the laser processing machine (1), which has a laser beam source (2) for generating the laser beam (5) and the processing optical assembly (3), and

a device (101) as claimed in any of the preceding claims, comprising an alignment element (103) and an imaging unit (111),
wherein the processing optical assembly (103) has an optical unit (11) effecting beam shaping with an optional aberration correction and a focusing lens unit (13),

wherein the optical unit (11) is configured for the processing of the workpiece (9) having a workpiece surface (9A), the geometry of which corresponds to the geometry of an entrance surface (103A) of the alignment element (103), and

wherein the optical unit (11) together with the focusing lens unit (13) is designed for the beam shaping of the laser beam (5) into a processing laser beam (5A) which propagates along an incident beam axis (21) and which can lead to the formation of the preset Bessel beam focus zone (7) in the workpiece (9) to be processed along a target axis (110), and

wherein the preset Bessel beam focus zone (7), proceeding from an impingement point (109) on the, in particular inclined or curved, workpiece surface (9A), extends, in an aberration-correcting manner, into the workpiece (9) to be processed along the target axis (110), and

wherein
the laser processing machine (1) furthermore comprises a first mount (15), in which the optical unit (11) is held laterally positionably in relation to the laser beam (5), and
the alignment element (103) of the device (101) is oriented and positioned in relation to the processing optical assembly (103) in such a way that a processing laser beam (5A) that is incident on the alignment element (103), instead of the workpiece (9) to be processed, along the incident beam axis (21) emerges as measurement laser beam (105) from the alignment element (103), such that a far field of the measurement laser beam (105) is formed on a detector area of the device (101).

The laser processing machine (1) can furthermore comprise a second mount (17), in which the focusing lens unit (13) is held, in relation to the optical unit (11), laterally positionably and optionally orientably in an optical axis of the focusing lens unit (13).

The optical unit (11) can be a planar diffractive optical element configured to impose a Bessel beam shaping phase on the laser beam (5) by way of a beam profile of the laser beam (5).

A thickness of the alignment element (103) can correspond at least to a length of the preset Bessel beam focus zone (7) proceeding from a predetermined impingement point (109) of the preset Bessel beam focus zone (7) along the target axis (110).

A method for aligning a processing optical assembly (3) in a laser processing machine (1), wherein the processing optical assembly (3) has a beam shaping optical unit (11) and a focusing lens unit (13), wherein the optical unit (11) is positioned in the beam path of a laser beam (5) of the laser processing machine (1) with a first mount (11A) and is configured for phase imposing on a lateral beam profile of the laser beam (5), wherein optionally the phase imposing has an aberration correction phase component configured for the precompensation of an aberration given upon entrance into a workpiece (9) to be processed at a predefined impingement point (109) at a predefined angle of incidence, such that given a correct alignment of the processing optical assembly (3) with the focusing lens unit (13), a processing laser beam (5A) impinging at a predefined impingement point (109) at a predefined angle of incidence and, in the workpiece (9), a preset Bessel beam focus zone (7) are generated, and wherein a device (101) as claimed in any of claims 1 to 10, comprising an alignment element (103) and an imaging unit (111), is used, comprising the following steps:

pre-aligning (step 201) the processing optical assembly (3) and the device (101), such that a laser beam (5) experiences phase imposing and is focused as a processing laser beam (5A) onto the alignment element (103) by the focusing lens unit (13),
orienting (step 203) the alignment element (103) in such a way that according to the aberration correction phase component optionally provided, the processing laser beam (5A) impinges on the alignment element (103) along an incident beam axis (21) of the device (101),
imaging (step 205) a far field of a measurement laser beam (105) emerging from the alignment element (103) onto an analysis plane, and
aligning (step 207) the position of the optical unit (11) and optionally of the focusing lens unit (13) in such a way as to result in a substantially rotationally symmetrical beam profile (131) of the measurement laser beam (105) in the analysis plane.

In the context of the concepts disclosed herein, the beam shaping optical unit can be positioned in the beam path of the laser beam and can be configured for phase imposing on a lateral beam profile of the laser beam, wherein the phase imposing has an aberration correction phase component configured for the precompensation of an aberration experienced by the laser beam upon entrance into the workpiece to be processed or the alignment element at a predefined initial position at a predefined angle of incidence, such that given a correct alignment of the processing optical assembly by means of focusing of the phase-imposed laser beam into the material at the predefined initial position at the predefined angle of incidence, the desired Bessel beam focus zone is generated and in particular an intensity ring that is rotationally symmetrical in terms of shape and intensity is formed in the far field on the detector area.

In some embodiments, the target axis can correspond to a longitudinal axis of the desired Bessel beam focus zone in the aligned state.

In some embodiments, an independent system comprising alignment element and objective lens and optionally the detector is formed in a housing or on an alignment plate.

Furthermore, the coordination of the surface with the beginning of the intensity zone can also be included in the alignment. By way of example, starting from the surface it is possible to effect a “self-healing” during the formation of the Bessel beam focus zone and it is possible to provide the aberration correction for the beginning of the intensity zone at the surface.

In the context of the concepts disclosed herein, the workpiece imitation (alignment element) is (substantially) transparent optically in the wavelength range of the laser beam and preferably has optical properties, such as refractive index and transparency, which are comparable with the workpiece to be processed. By way of example, the workpiece imitation consists of a material having a refractive index which, in a wavelength spectrum of the laser beam, is comparable with a refractive index of the workpiece to be processed. A refractive index of the material of the workpiece imitation is comparable with the refractive index of the workpiece to be processed e.g. if the refractive index of the material of the workpiece imitation differs from the refractive index of the workpiece to be processed in the wavelength spectrum of the laser light by e.g. less than 5% or less than 10%.

Furthermore, the entrance surface of the workpiece imitation has a geometry which corresponds to a geometry of a workpiece surface of a workpiece to be processed in a region of the surface through which the processing beam enters the workpiece. Furthermore, a thickness of the workpiece imitation can correspond at least to a length of the preset Bessel beam focus zone proceeding from a predetermined impingement point for a Bessel beam focus zone along the target axis.

Optionally, for simplifying the orientation of the processing laser beam 5A relative to the workpiece imitation, a marking can be provided on the entrance surface 103A. Said marking marks e.g. in color a preferred position of the impingement of the processing laser beam (e.g. the impingement point 109 in FIG. 3). During an orientation—corresponding to the later processing process—of the workpiece imitation with respect to the processing laser beam and impingement of the processing laser beam on this marked position, the orientation of the measurement focus zone—assuming a correct alignment of the processing head—corresponds to the orientation of the Bessel beam focus zone required for the processing process.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for aligning a processing optical assembly of a laser processing machine, the processing optical assembly being configured to shape a laser beam in the laser processing machine and to focus the laser beam along an incident beam axis so that a processing laser beam forms a preset Bessel beam focus zone in a workpiece to be processed, the device comprising:
an entrance region for receiving the processing laser beam,
a focus zone forming region for forming a measurement focus zone by the received processing laser beam along a target axis, and
an imaging unit having a lens and a detector surface, wherein the lens is configured to image measurement laser radiation that leaves the focus zone forming region after the measurement focus zone has been formed, along an imaging axis predefined by the target axis, onto the detector surface.

2. The device as claimed in claim 1, wherein the lens and the detector surface are arranged along the imaging axis, and the detector surface is part of a camera, wherein the lens is characterized by a lens axis that is parallel to the imaging axis, and the detector surface extends in a plane to which the imaging axis runs perpendicularly.

3. The device as claimed in claim 1, wherein the imaging unit comprises a stop for mounting a workpiece imitation, wherein the stop defines a stop area in a predetermined orientation with respect to the imaging axis, and
wherein the stop area is configured for an orthogonal orientation of a plane exit surface of the workpiece imitation with respect to the target axis.

4. The device as claimed in claim 1, wherein the imaging unit comprises at least one of:
a first translation unit for displacing the lens along the imaging axis,
a second translation unit for displacing the detector surface along the imaging axis, or
a third translation unit for jointly displacing the lens and the detector surface along the imaging axis.

5. The device as claimed in claim 1, further comprising a rotation unit configured for rotatable mounting of the imaging unit in order to provide a rotation of the imaging axis with respect to the incident beam axis.

6. The device as claimed in claim 1, further comprising:
a workpiece imitation as an alignment element, wherein the workpiece imitation has an entrance surface and a plane exit surface and is arranged in the focus zone forming region so that
the plane exit surface is oriented perpendicularly to the target axis,
the entrance surface, at an impingement point at which the processing laser beam impinges on the workpiece imitation along the incident beam axis, is arranged with respect to the incident beam axis so that the target axis running through the workpiece imitation runs in a predefined direction given by the preset Bessel beam focus zone.

7. The device as claimed in claim 6, wherein the imaging unit further comprises a stop for mounting the workpiece imitation, wherein the stop defines a stop area for mounting the workpiece imitation in a position in which the plane exit surface is oriented perpendicularly to the imaging axis.

8. The device as claimed in claim 6, wherein an orientation of the target axis with respect to the incident beam axis is given by a refractive index of the workpiece imitation and is defined in relation to an impingement point of the processing laser beam along the incident beam axis.

9. The device as claimed in claim 6, wherein the entrance surface forms in sections a shape of a lateral surface of a cylinder, and wherein in the case of a radial course of the incident beam axis with respect to the shape of the lateral surface of the cylinder, the plane exit surface runs perpendicularly to the incident beam axis.

10. The device as claimed in claim 6, wherein the target axis runs orthogonally or non-orthogonally with respect to a tangential plane at the impingement point of the entrance surface, and
wherein the incident beam axis runs at an angle in the range of 0° to 50° with respect to a normal vector of the tangential plane.

11. The device as claimed in claim 1, wherein the imaging unit
in a first operating setting is configured to capture a transverse beam profile of the measurement laser radiation in a far field, and
in a second operating setting is configured to, by positioning the lens and the detector surface, to image a start or an end of a measurement focus zone formed in the workpiece imitation onto the detector surface.

12. A system for aligning a processing optical assembly in a laser processing machine, wherein the processing optical assembly is configured for generating a preset Bessel beam focus zone in a substantially transparent workpiece by imposing a phase profile on a laser beam, the system comprising:
the laser processing machine comprising a laser beam source for generating the laser beam and the processing optical assembly, and
a device as claimed in claim 1, comprising an imaging unit and a workpiece imitation,
wherein the processing optical assembly comprises a beam shaping optical unit and a focusing lens unit,
wherein the beam shaping optical unit is configured for processing the workpiece having a workpiece surface, the a geometry of the workpiece surface corresponds to a geometry of an entrance surface of the workpiece imitation, and
wherein the beam shaping optical unit together with the focusing lens unit is configured for beam shaping of the laser beam into a processing laser beam that propagates along an incident beam axis and leads to formation of the preset Bessel beam focus zone in the workpiece to be processed along a target axis, and
wherein the preset Bessel beam focus zone, proceeding from an impingement point on the workpiece surface, extends into the workpiece to be processed along a target axis, and
wherein
the laser processing machine further comprises a first mount, in which the beam shaping optical unit is held laterally positionably in relation to the laser beam, and
the device is configured and positioned in relation to the processing optical assembly so that the processing laser beam which enters the device along an incident beam axis impinges as measurement laser radiation in a far field on a detector surface of the imaging unit.

13. The system as claimed in claim 12, wherein the workpiece imitation of the device is oriented and positioned in relation to the processing optical assembly so that the processing laser beam which is incident on the workpiece imitation along the incident beam axis emerges from the workpiece imitation as the measurement laser radiation.

14. The system as claimed in claim 12, wherein the laser processing machine further comprises a second mount, in which the focusing lens unit is held positionably in relation to the optical unit laterally and along an optical axis of the focusing lens unit.

15. The system as claimed in claim 12, wherein a camera of the imaging unit is configured for outputting an image recording of a beam profile in a far field of the measurement laser radiation emerging from the workpiece imitation.

16. The system as claimed in claim 12, wherein the beam shaping optical unit comprises a planar diffractive optical element configured to impose a two-dimensional Bessel beam shaping phase distribution on the laser beam.

17. The system as claimed in claim 14, wherein in an aligned state of the processing optical assembly, the first mount positions the beam shaping optical unit and the second mount positions the focusing lens unit in such a way that a beam profile of a far field on the detector surface is substantially rotationally symmetrical with respect to the imaging axis.

18. The system as claimed in claim 12, wherein a region in which a geometry of the entrance surface of the workpiece imitation corresponds to a geometry of the workpiece surface of the workpiece to be processed, which forms the basis for the preset Bessel beam focus zone, is dimensioned in such a way that a measurement focus zone is formed in the workpiece imitation substantially over a length of the preset Bessel beam focus zone.

19. A method for aligning a processing optical assembly in a laser processing machine, wherein the processing optical assembly has a beam shaping optical unit and a focusing lens unit, wherein the beam shaping optical unit is positioned in a beam path of a laser beam of the laser processing machine with a first mount and is configured for phase imposing on a lateral beam profile of the laser beam, such that in the case of a correct alignment of the processing optical assembly with the focusing lens unit for a processing laser beam impinging at a predefined impingement point at a predefined angle of incidence in the workpiece a Bessel beam focus zone is generated, comprising the following steps:
pre-aligning the processing optical assembly and the device, such that the laser beam experiences phase imposing and is focused by the focusing lens unit as a processing laser beam into a focus zone forming region into the optional workpiece imitation,
orienting the workpiece imitation in such a way that the processing laser beam is incident in the device along an incident beam axis and impinges on the workpiece imitation,
imaging a far field of a measurement laser radiation emerging from the workpiece imitation onto an analysis plane, and
aligning the position of the beam shaping optical unit and the focusing lens unit in such a way as to result in a substantially rotationally symmetrical beam profile of the measurement laser radiation in the analysis plane, and
wherein a device as claimed in claim 1 comprising an imaging unit and a workpiece imitation is set in order to image the far field of the measurement laser radiation onto the analysis plane.

20. A method for measuring a length of a Bessel beam focus zone, to be generated by a laser processing machine in a workpiece, wherein the laser processing machine has a processing optical assembly comprising a beam shaping optical unit and a focusing lens unit, wherein the optical unit is configured for phase imposing on a lateral beam profile of a laser beam, such that for a processing laser beam emerging from the focusing lens unit and impinging at a predefined impingement point at a predefined angle of incidence in the workpiece a preset Bessel beam focus zone is generated along a target direction, the method comprising the following steps:
aligning the processing optical assembly according to the method as claimed in claim 19, such that the processing laser beam is focused into the focus zone forming region into the workpiece imitation, while forming a measurement focus zone, and
scanning the measurement focus zone by focusing the measurement laser radiation emerging from the workpiece imitation, by using a lens, onto an analysis plane while displacing the lens along an imaging axis.
